(19) United States
(12) Patent Application Publication
(10) Pub. No.: US 2008/0069326 A1
(43) Pub. Date: Mar. 20, 2008

(54) Method of integrating an intercom system and a mobile communication device

(76) Inventor: Chi-Yuan Chang, Taipei (TW)

Correspondence Address: BIRCH STEWART KOLASCH & BIRCH, PO BOX 747, FALLS CHURCH, VA, 22040-0747, US

(21) Appl. No.: 11/511,327

(22) Filed: Aug. 29, 2006

(51) Int. Cl. H04M 9/00

(52) U.S. Cl. 379/167.11

(57) ABSTRACT

A method allowing the audio and video signals of an intercom system to be extended to a mobile communication device via Internet is provided. A server device functions as a relay between a residence-end device of the intercom system and a mobile communication device. The server device is able to forward the audio and video signals from the residence-end device to the mobile communication device through the Internet. Correspondingly, the voice, video, and control signals from the mobile communication device are passed to the server device which in turn feeds the signals to the voice, video, and control circuits of the residence-end device.

### BACKGROUND OF THE INVENTION

1. Field of the Invention

The present invention generally relates to an intercom system, and more particularly to a method allowing the audio and video signals of the intercom system to be extended to a mobile communication device via Internet.

2. The Prior Arts

The conventional design of security systems is to trigger the alarm, to alert the authority, or to preserve the evidence by audio or video recording, only after unauthorized personnel has broken into the secured perimeter. This design concept has been proven to be an effective one in the past. However, a more active approach is to intimidate an intruder even before his or her choice of a target and engaging the breaking-in.

A common tactic of a burglar in picking a target is to impersonate a mailman or a technician from the phone company or a cable guy and to use the intercom system of a house or an building to see if someone is in. If there is no one answering the intercom, this place would very likely become the next target of the burglar.

A common intercom system contains a visitor-end device installed at the main entrance to the house or the apartment building, and a residence-end device installed inside the house or in each apartment. These residence-end devices are usually connected to the visitor-end device in parallel connections via appropriate cabling. Traditional intercom systems provide two-way voice communications between the visitor-end device and the residence-end device while more advanced systems additionally provide one-way or two-way video capability. For an intercom system with one-way video capability, the visitor-end device usually contains a camera, a microphone, a speaker, and at least a ring button. The residence-end device, on the other hand, contains a display, a microphone, a speaker, and a control button to open the door at the main entrance where the visitor-end device is installed. When a visitor presses the ring button, a buzz or ring is sounded from the residence-end device and, in the mean time, the images captured by the camera of the visitor-end device are shown on the display of the residence-end device. People in the house or apartment are therefore able to see and converse with the visitor. After the visitor is identified, the door is opened by the control button. The intercom systems with two-way video capability are very much similar to the foregoing one-way system except that visitor-end device has an additional display and the residence-end device has an additional camera so that both parties can see each other.

On the other hand, mobile handsets are gaining widespread popularity in recent years. Accompanied with the technology advancement, the mobile handsets have evolved from a pure voice communication device to a gadget with multimedia capability. Typical examples are those MP3 phones which can playback music recordings in MP3 format, and those so-called camera phones that can capture still images or conduct video recordings.

The present invention therefore arises from a concept to integrate the intercom system with a mobile handset and, through such an integration, an away-from-home user can interact with a visitor ringing at the door of his or her house/apartment to create an impression that someone is currently in. A burglar is therefore alerted and continues to find the next target.

### SUMMARY OF THE INVENTION

Based on the foregoing concept, the present invention provides a method to notify a user of a mobile communication device that a visitor has triggered the intercom system to his or her house/apartment, and to allow the user to conduct two-way voice communications with the visitor through the mobile communication device. If the intercom system has the aforementioned one-way video capability, the method also allows the user to see the images of the visitor from the display of the mobile communication device. If the intercom system has the two-way video capability, the method can further allow the user to choose whether to pass the images captured by the camera of the mobile communication device to the display of the visitor-end device. The user can also open the door of the house/apartment directly from the mobile communication device.

The most significant feature of the present invention is to rely on a server device, the Internet, and the mobile data function of the mobile communication device to establish the voice, video, and control link between the mobile communication device and the residence-end device. When a user leaves his or her house/apartment, the user first establishes a connection to the Internet from the mobile communication device, and the user then registers the network address of the mobile communication device to the server device. The server device is therefore able to communicate with the mobile communication device via the Internet. On the other hand, the server device is connected to the voice, video, ringing, and control circuits of the residence-end device. As such, the server device is able to detect whether a visitor has triggered the intercom system to the user's house/apartment through the ringing circuit. The server device is then able to digitize that analog signals of the voice and video circuits, package the digitized data into network packets, and forward the packets to the mobile communication devices following an appropriate protocol through the Internet. Correspondingly, the voice, video, and control signals from the mobile communication device are also digitized and passed to the server device following the protocol through the Internet. The server device in turn converts the packets into analog signals and feeds the signals to the voice, video, and control circuits of the residence-end device.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a schematic diagram showing a system according to an embodiment of the present invention.

FIG. 2 is a flow diagram showing the processing steps according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The mobile communication devices referred in the present specification are those devices supporting mobile data functions conforming to 2.5G or 3G or future-developed standards, having relevant human interfaces such as camera, microphone, speaker, earphone, etc., for video and audio capturing and playing. Some typical examples are those currently popular camera phones and personal digital assistants (PDAs) with appropriate modules installed. As will be described later, a portion of the method provided by the present invention is implemented as a software module installed inside the mobile communication device. Depending on the hardware/software platform and the I/O interface supplied by the mobile communication devices, the software module may require different installation procedures. For example, the software module can be downloaded into the mobile communication devices from a server via Internet or from another device by a wired link (via, for example, USB port) or wireless link (via, for example, Infrared or Bluetooth®).

The intercom system referred in the present specification is one installed in a house or an apartment building or a similar multi-tenant environment capable of providing one-way or two-way video transmission and display functions. The present invention does not require any modification to either the visitor-end devices of the intercom system or the cabling between the visitor-end devices and the residence-end device. The residence-end device can be one specifically designed for the present invention or an existing one with its audio, video, and control circuits appropriately connected to a server device which will be described in the following.

The embodiment of the present invention described as follows assumes an intercom system having two-way video function. Embodiments involving intercom systems capable of one-way video function can be easily deduced and therefore are not described here.

The present invention requires a server device functioning as a relay between the residence-end device and the mobile communication device. The server device can be an ordinary computing device such as a desktop or server computer having an appropriate interface for connection to the residence-end device. A portion of the present invention therefore can be implemented as a software module installed (e.g., on the hard disk drive) in the computing device. As to the appropriate interface, it can include a video capture board, a voice board, an I/O control board installed in the expansion slots of the computing device under the control of the software module so that the video, audio, and control signals can be exchanged between the residence-end device and the computing device. The server device can also be a proprietary and independent device specifically dedicated to the support of the present invention. The proprietary device is usually still a computing device having a processor, memory, buses and so on but with all the required interface boards integrated. The software module is usually implemented as firmware stored in a flash memory of the proprietary device. There are also embodiments where the server device is a device sitting between the residence-end device and a computer and is under the control of the computer.

Therefore, the server device referred in the present specification is an abreaction of one or more devices relaying video, audio, and control signals between the residence-end device and the mobile communication device. In the following embodiment, the server device is assumed to be a proprietary one and the other types of server devices can be easily deduced. Please note that the server device according to the present invention should have a network interface so as to be connected to the Internet. This can be achieved in various ways. For example, in one embodiment, the server device has a RJ45 network port linked directly to an ADSL modem through which the Internet connectivity is established. In another embodiment, the RJ-45 port is connected to an Ethernet-based wired LAN which in turned is connected to the ADSL modem. In yet another embodiment, the LAN is a wireless one conforming to one of 802.11 a/b/g standards. Regardless of how the Internet connectivity is established, the server device should have network identity such as a network address or domain name by which other devices can access the server device from anywhere on the Internet.

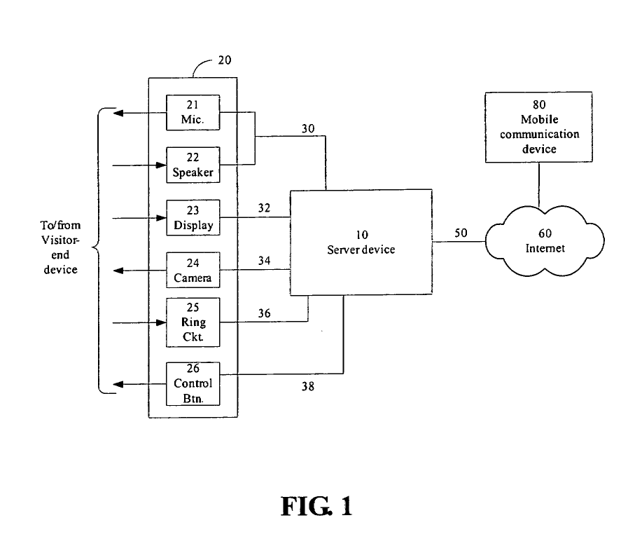

FIG. 1 is a schematic diagram showing a system according to an embodiment of the present invention. As illustrated, a system where the present invention is implemented contains a server device 10 having the following connections to a residence-end device 20. One of the connections is a voice link 30 connected to the audio capturing circuit (microphone 21) and audio playing circuit (speaker 22) so as to provide a two-way voice channel. Another two connections are a video input link 32 connected to the display 23 of the residence-end device 20, and a video output link 34 connected to the camera 24 of the residence-end device 20. Yet another two connections are a ringing link 36 connected to the ringing circuit 25 of the residence-end device 20, and a control link 38 connected to the control button 26 of the residence-end device 20.

The server device 10 is connected to the Internet 60 via a link 50. As mentioned earlier, the link 50 involves one of various linking techniques such as ADSL. For simplicity, the link 50 is used to abstractly represent the combination of devices between the server device 10 and the Internet 60.

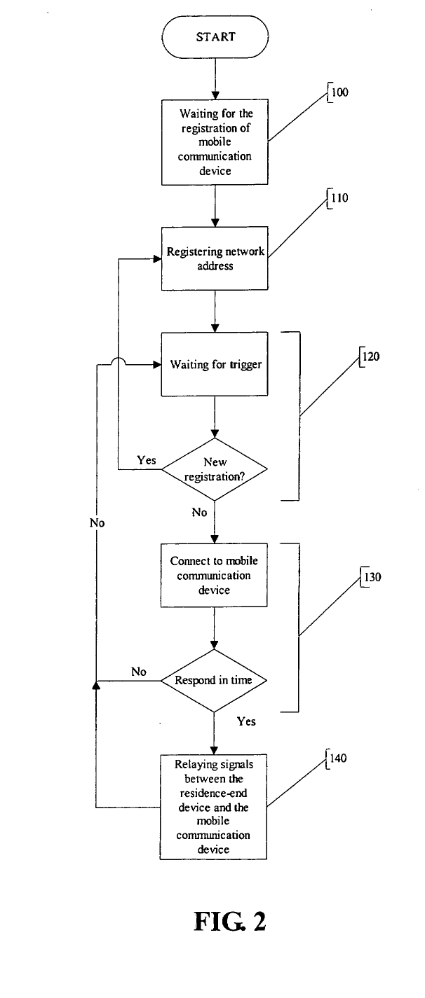

FIG. 2 is a flow diagram showing the processing steps of the server device 10 according to an embodiment of the present invention. In step 100, when the server device 10 is started, it enters a stand-by mode waiting for the registration of the mobile communication device 80. If there is no mobile communication device 80 registering in the server device 10 and a visitor has triggered the residence-end device 20, the server device 10 will remain in the stand-by mode without making any response.

In step 110, a user of the mobile communication device 80 connects the mobile communication device 80 to the Internet 60 by activating the mobile data function of the mobile communication device 80 which will be assigned a network address in the process. Then, through a browser of the mobile communication device 80 and by specifying the network identity of the server device 10, the user can connect the mobile communication device 80 to a web page provided by the server device 10. In the connection process, the server device 10 will obtain the network address of the mobile communication device 80 and store the network address in a memory of the server device 10. In some embodiments, the foregoing registration process can be automated, instead of through a manual process as described, by the software module installed in the mobile communication device 80. Some embodiments will also provide a notification in the web page about the successful registration of the mobile communication device 80.

If the mobile communication device 80 is turned off or its link to the Internet is interrupted after registration, the mobile communication device 80 will obtain a new network address after restart and re-connecting to the Internet 60. The new network address has to be registered in the server device 10 to replace the original obsolete network address. To avoid that the network address of the mobile communication device 80 is accidentally overwritten by unauthorized connections, some embodiments would provide a web page in the server device 10 requesting the input of a correct password for authentication. This password could be preset in the server device 10 while some embodiments allow a user to configure or change the password. There are also some embodiments in which the mobile communication device 80 can automatically supply the correct password to the server device 10 so as to save the effort of manual entry.

In step 120, the server device 10 enters another stand-by mode waiting either for a signal on the ringing link 36 resulted from a visitor's trigger to the ring button or a new registration from a mobile communication device 80. If the latter happens, the flow returns to the step 110 to receive the new registration.

If a visitor presses the ring button of the visitor-end device corresponding to the residence-end device 20, an AC ring voltage will propagate to the server device 10 via the ringing link 36. After detecting the presence of the ring voltage on the ringing link 36, the flow enters the step 130 where the server device 10 tries to connect the mobile communication device 80 based on the registered network address. If the mobile communication device 80 does not respond within a period of time due to the mobile communication device 80's being outside of the coverage, turning off, or other reasons, the server device 10 will not respond to the visitor trigger. The flow will return to the step 120 to wait for next trigger. In some embodiments, the server device 10 will record the time and other relevant event information about all visitor triggers for later review. There are also embodiments which will only record the un-responded visitor triggers in some internal memory (e.g., the hard disk drive or some non-volatile memory). Some embodiments will issue short messages or emails to a specific party. Please note that, to achieve the foregoing function, some parameters have to be configured in the server device 10 such as the network address of an email server, ID and password for logging into the email server.

The software module inside the mobile communication device 80 will be triggered as the mobile communication device 80 is reached by the server device 10. If the mobile communication device 80 responds within a period of time, the flow will enter the step 140 where the server device 10 forwards the audio and video signals received from the audio link 30 and the video input link 32 to the mobile communication device 80 after digitizing, coding, packetizing, and delivering the signals in accordance with a specific protocol. Correspondingly, the software module in the mobile communication device 80 also forwards the audio and video signals received from its microphone and camera to the server device 10 after digitizing, coding, packetizing, and delivering the signals in accordance with the specific protocol. After receiving the packets from the other party, both the server device 10 and the mobile communication device 80 convert the packets back into analog audio and video signals. The server device 10 passes the audio and video signals into the residence-end device 20 via the audio link 30 and the video output link 34 respectively. The residence-end device 20 in turn forwards these signals to the speaker and the display of the visitor-end device where the signals are presented. Similarly, the analog audio and video signals are presented on the speaker and display of the mobile communication device 80. As described, a two-way communication is thereby established between the visitor-end device and the mobile communication device 80.

In some embodiments, the intercom system, even though with two-way video function, can be configured to provide one-way video communications only. In other words, only the visitor's image will be presented on the display of the mobile communication device 80 while the visitor will not see anything on the display of the visitor-end device. The configuration for turning the two-way video function into a one-way function can be provided by software module either in the server device 10 or in the mobile communication device 80.

After recognizing the visitor's identity (e.g., a family member forgetting to carry the key), the user of the mobile communication device 80 can use a specific key or key combination of the mobile communication device 80's keypad (e.g., pressing the digit ‘9’ for an extended period of time) to issue a control signal to open the door for the visitor. The control signal is transmitted via the aforementioned mechanism to the server device 10 which in turn passes the control signal via the control link 38 to the residence-end device 20 and subsequently to a gate opening mechanism controlled by the control button 26.

When the software module in the mobile communication device 80 is turned off by the user or due to other reasons, the software module will issue a “hang-up” control signal to the server device 10. Upon receiving the control signal, the server device 10 will return to the step 120 to become standing-by. On the other hand, if the communication between the server device 10 and the mobile communication device 80 remains idle for a period of time, the server device 10 will automatically return to the step 120.

In some embodiments, the server device 10 can additionally records the audio and video signals synchronously in the hard disk drive for review in later days.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of integrating an intercom system and a mobile communication device, said intercom system having a residence-end device and a visitor-end device with an appropriate cabling therebetween, said intercom system providing two-way audio communications and at least one-way video communications from said visitor-end device to said residence-end device, said mobile communication device having an audio interface, a video interface, and a mobile data function, comprising the steps of:
providing a server device having a first link to said residence-end device and a second link to Internet, said server device having a network identity;
connecting said mobile communication device to Internet by specifying said network identity and obtaining a network address for said mobile communication device; and registering said network address in said server device via Internet and said second link;
connecting said server device to said mobile communication device based on said network address in response to said server device's receiving a ring signal from said visitor-end device via said residence-end device and said first link; and
converting and forwarding a first audio signal and a first video signal from said visitor-end device via said first link and said server device to said mobile communication device; converting and forwarding at least a second audio signal from said mobile communication device to said server device; presenting said fist audio and video signals on said mobile communication device; presenting said second audio signal on said visitor-end device via said residence-end device and said first link.

2. The method according to claim 1, wherein said first link comprises an audio link connected to a speaker and a microphone of said residence-end device; a video input link connected to a display of said residence-end device; and a ringing link connected to a ringing circuit of said residence-end device.

3. The method according to claim 2, wherein said first link further comprises a control link connected to a control button of said residence-end device for opening a gate of said intercom system; and said method further comprising the step of:
converting and forwarding a control signal produced by a key combination of said mobile communication device to said server device and said residence device via said control link.

4. The method according to claim 2, wherein said mobile communication device comprises a camera; said first link further comprises a video output link connected to a camera of said residence-end device; said visitor-end device comprises a display connected to said camera; and said method further comprising the step of:
converting and forwarding a second video signal obtained from said camera of said mobile communication device to said server device and said residence device via said video output link; and presenting said second video signal on said display of said visitor-end device.

5. The method according to claim 1, wherein said step of registering said network address further comprises the step of:
authenticating said mobile communication device by requesting a password through an interface before registering said network address.

6. The method according to claim 1, wherein said step of registering said second network address is automatically carried out by said mobile communication device.

7. The method according to claim 5, wherein said password is automatically provided by said mobile communication device.

8. The method according to claim 1, wherein, in response to said server device's receiving said ring signal from said visitor-end device, said server device records relevant information about said trigger for later review.

9. The method according to claim 1, wherein, in response to said server device's receiving a ring signal from said visitor-end device, said server notifies a party with a short message or an email.

10. The method according to claim 1, wherein said first audio signal, said first video signal, and said second audio signal are synchronously recorded by said server device.

11. The method according to claim 4, wherein said first audio signal, said first video signal, said second audio signal, and said second video signal are synchronously recorded by said server device.
